(19) United States
(12) Patent Application Publication
(10) Pub. No.: US 2011/0179004 A1
(43) Pub. Date: Jul. 21, 2011

(54) METHOD AND SYSTEM FOR AN INTERNET BROWSER ADD-ON PROVIDNG SIMULTANEOUS MULTIPLE INTERACTIVE WEBSITES

(76) Inventor: Samir H. Safar, San Diego, CA (US)

(21) Appl. No.: 12/748,606

(22) Filed: Mar. 29, 2010

Related U.S. Application Data
(63) Continuation of application No. 12/688,478, filed on Jan. 15, 2010.

(51) Int. Cl. G06F 17/30; G06F 3/048

(52) U.S. Cl. 707/706; 715/760; 715/800; 707/E17.108

(57) ABSTRACT

The present invention describes a system and method of displaying and queuing search results and comprises a method of Internet browser add-ons or a web-based program where the multiple results from one or more search engines are displayed partially in one frame on one window screen and can be moved to a second frame so that the search results can be sorted and placed into a queue for later viewing. The invention is particularly, but not exclusively, useful as a system and methods with novel aspect to develop the Internet browser view more user friendly to the users and includes further a Download module to user computer and an Install/Remove module of the add-on software module.

### CROSS REFERENCE TO RELATED APPLICATIONS

This application is a continuation of U.S. patent application Ser. No. 12/688,478, entitled “METHOD AND SYSTEM FOR AN INTERNET BROWSER ADD-ON PROVIDING SIMULTANEOUS MULTIPLE INTERACTIVE WEBSITES ON ONE INTERNET BROWSER WINDOW”, filed on 10 Jan. 2010. The benefit under 35 USC §119(e) of the United States provisional application is hereby claimed, and the aforementioned application is hereby incorporated herein by reference.

This application is related to U.S. Provisional Patent Application Ser. No. 12/639,861, entitled “SYSTEM AND METHOD OF MULTI-PAGE DISPLAY AND INTERACTION OF ANY INTERNET WEBSITE PAGE DATA ON AN INTERNET BROWSER”, filed on 16 Dec. 2009. The benefit under 35 USC §119(e) of the United States provisional application is hereby claimed, and the aforementioned application is hereby incorporated herein by reference.

This application is related to U.S. Provisional Patent Application Ser. No. 61/205,109, entitled “Internet Browser add-on—multiple interactive websites on one Internet browser window of any Internet browser simultaneously”, filed on 15 Jan. 2009. The benefit under 35 USC §119(e) of the United States provisional application is hereby claimed, and the aforementioned application is hereby incorporated herein by reference.

This application is related to U.S. Provisional Patent Application Ser. No. 61/203,058, entitled “Internet Browser Multi-Webpage Display on One Screen Add-On Computer Software Module”, filed on 18 Dec. 2008. The benefit under 35 USC §119(e) of the United States provisional application is hereby claimed, and the aforementioned application is hereby incorporated herein by reference.

### TECHNICAL FIELD OF THE INVENTION

The present invention pertains to generally to systems and method of Internet browser add-ons where multiple websites of any website page gets displayed and interacted with simultaneously on one Internet browser window screen in a queue format. The invention is particularly, but not exclusively, useful as a system and methods of system with novel aspect to fortify development of Internet browser view.

### BACKGROUND OF THE INVENTION

The Internet is a valuable resource for providing users with information. In particular, consumers use the Internet to find information and make decisions among online entities such as websites, online merchants, online companies, or online services. Further, the Internet is evolving into a type of informational utility that helps the people to make important decisions and manage their day-to-day activities and needs. However, the amount of information available online is so large that it may be difficult to find relevant information.

The way Internet Browsers such as MICROSOFT EXPLORER, FIREFOX and

GOOGLE CHROME display of information is a problem that people face every day when they search for particular information. It is difficult to view more than on website simultaneously without opening another thread, browser window, or tab within a browser which takes more of the computer processing resources and they pages are typically stacked one behind the other.

What is needed is an add-on model for the next generation of Internet browsers that provides for the interaction and display of information, which not only solves the major multi-website display problems, but also reduces the cost and time a computer user spends finding and comparing information.

### SUMMARY OF THE INVENTION

The present invention describes a system and method of displaying website pages and comprises a method of Internet browser add-ons where the multi-page of the Internet website page data is displayed by queuing a user's search and then stacking the search pages in a queue instead of in columns partially on one window screen in multi-column format where each column represents one website page of data. The invention is particularly, but not exclusively, useful as a system and methods with novel aspect to develop the Internet browser view more user friendly to the users and includes further a Download module to user computer and an Install/Remove module of the add-on software module. The present invention teaches a queue configuration display of Internet website pages such as GOOGLE, YAHOO, or MSN/BING that displays multiple queues of results from one or more search engines on one window screen. The computer mouse drags the edge of each frame to the left or right of the window screen to increase or decreases the width of the frames. The present invention can display multiple queues of results of any website pages in one browser window.

The main components of the present invention include an add-on software module to an Internet browser that is download via a software module to a user's computer for execution, and includes an install/remove module of the add-on software module. The physical apparatus required to enable one embodiment of the present invention includes a web server; a web portal interface; a multi-user network; and an application server.

The program module is an add-on to a browser; a User can select one or more queues to be displayed when surfing the Internet. Each queue represents one website page of data. It is downloaded from a server that on the Internet. It interfaces with MS EXPLORER, FIREFOX, SAFARI and GOOGLE CHROME. Users can condense or expand the frames by clicking and dragging on the side border, left or right, to read more of the text of a specific frame. Additionally, a user can use a top or side scroll of each frame to view more of the frame without expanding the queues. The top and side scroll was developed so a user does not have to scroll to the bottom of a frame to engage a scroll feature every time.

Businesses invest huge amount of money to have multi web pages displayed and interacted with by purchasing software and computer terminals to display and interact with multi website simultaneously, such as stock market, research and development, or marketing business. Currently, Internet users have to click back and forth between Internet Browser's tabs to view web pages of the same or different website for review, study or shopping comparison.

Additionally, currently Internet users have to open multi-browser windows to view more than website at the same time on their computer screen.

Therefore it is an objective of the present invention to teach a display multi search results of any website on one browser window.

It is another objective of the present invention to teach a method for displaying and interacting with multiple websites of any site pages on one Internet browser window.

It is yet another objective of the present invention to teach a method the will require less computer processing resource needed, since we open only one Internet browser to view multiple search results simultaneously.

It is still another objective of the present invention to teach a system and method where a user can see multiple search engine results at one time.

Therefore what is needed is an Internet website page display of information, that will not only solve the major problems previously discussed, but will reduce the cost of paying for such related services. Businesses will reduce the time and money surfing and searching the Internet for research and information comparison. This will result in less terminals needed to display and interact with or to be purchase to interact with multiple websites.

### BRIEF DESCRIPTION OF THE DRAWINGS

The accompanying drawings, which are incorporated herein an form a part of the specification, illustrate the present invention and, together with the description, further serve to explain the principles of the invention and to enable a person skilled in the pertinent art to make and use the invention.

FIG. 1 is a representative screen image of the home page of the present invention;

FIG. 2 is a representative screen image of the search results of a simple one engine, one term simulated search;

FIG. 3 is a representative screen image of a simulated keyword search and results;

FIG. 4 is a representative screen image of a web queue;

FIG. 5 is a representative screen image of an image queue;

FIG. 6 is a representative screen image of a website image queue;

FIG. 7 is a representative screen image of a jobs queue;

FIG. 8 is a representative screen image of emptying a user's queue; and

FIG. 9 is a representative screen image of the multiple search engine results stacking in the second frame, illustrating the sub-frames of the second frame used for displaying the search engine results of multiple search engines.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

The physical apparatus required to enable one embodiment of the present invention includes a web server; a web portal interface; a multi-user network; and an application server. The application server provides a means for allowing a local user computer to download and install the add-on software module taught by the present invention to any Internet browser.

The method of the present invention may also be recorded onto a CD, or any other recordable medium as well as being delivered electronically from a database to a computer, wherein the method embodied by the software that is recorded is then executed by a computer for use and transformation of the Internet browser and its contents.

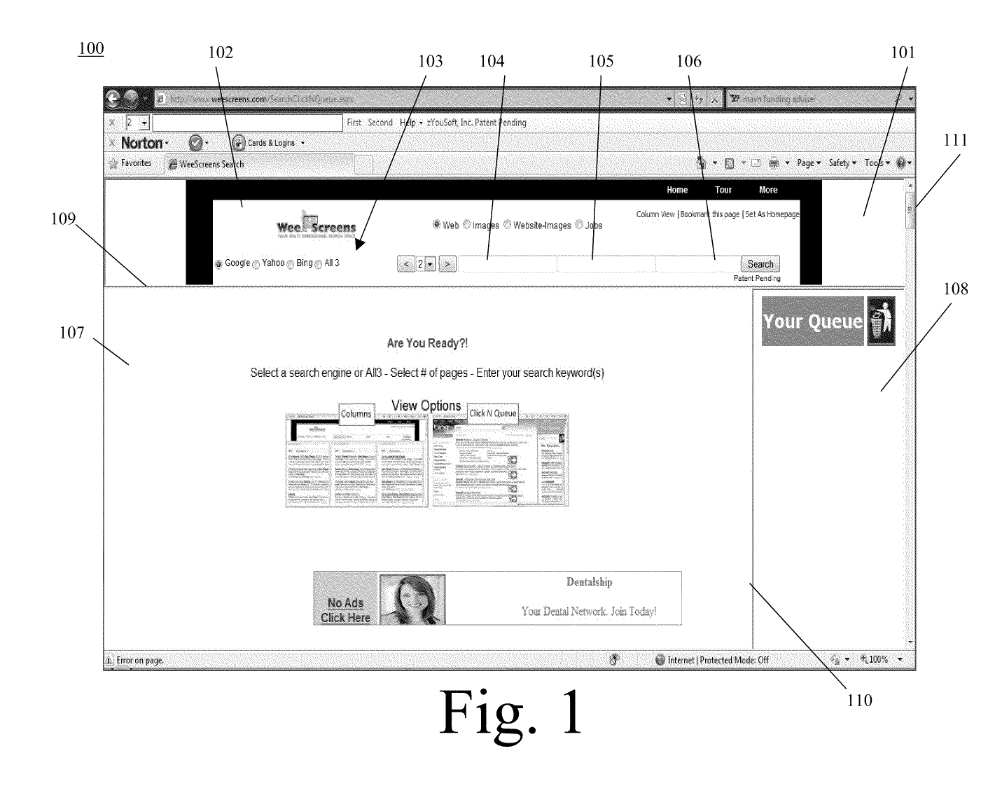

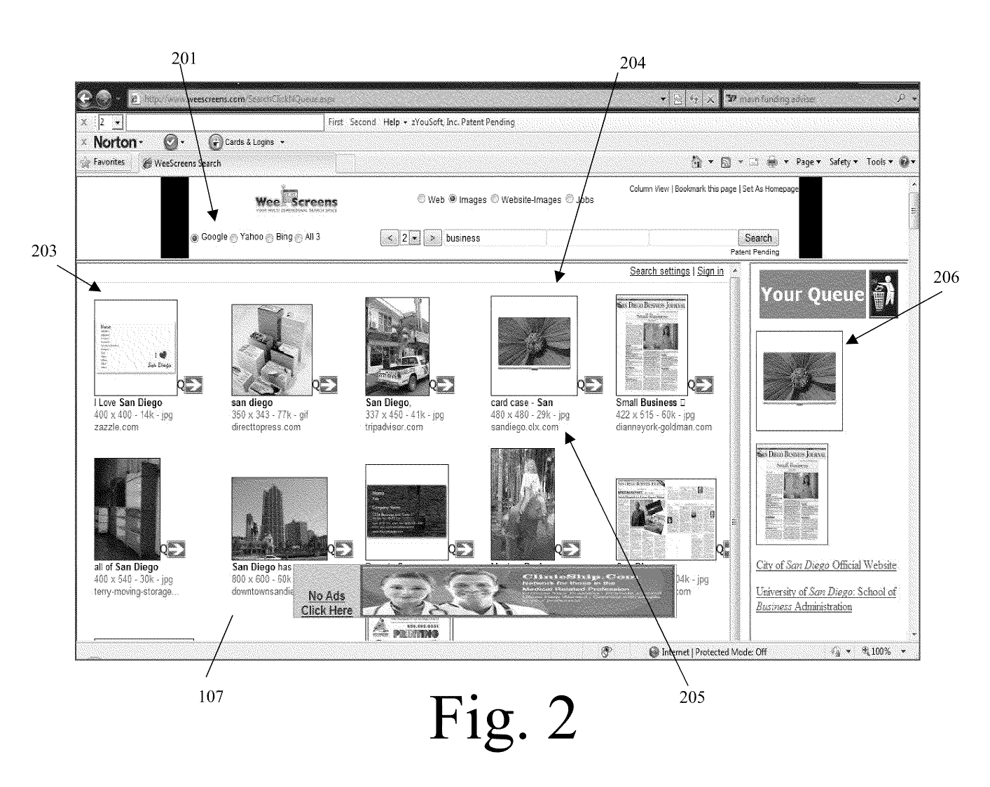

The main components of the present invention, as shown in FIGS. 1 and 2, include the Main Internet browser screen 100, a first frame 101 providing a searching interface 102 providing for a selection of one or more search engines 103 and cells 104, 105, and 106 for entering one or more search terms. A second frame 107 for displaying search results and a third frame 108 for displaying a queue of search results. A first boundary 109 separates the first frame 101 from the second frame 107 and third frame 108. A second boundary 110 separates the second frame 107 from the third frame 108 and provides a means for searching results in the second frame 107. An additional scroll bar 111 is provided for searching the third frame 108 in a scrolling manner.

As shown in FIG. 1, the present invention describes a system and method of displaying a plurality of search results from one or more search engines and comprises a method of Internet browser add-ons where the pages of a website found on the Internet are displayed partially on one window screen in a multi-frame format, where the first frame 101 provides search engine selection and search term entry, a second frame 107 displays search results, and a third frame 108 is provided to queue selected search results from the second frame 107. The invention is particularly, but not exclusively, useful as a system and methods with novel aspect to develop the Internet browser view more user friendly to the users and includes further a Download module to user computer and an Install/Remove module of the add-on software module.

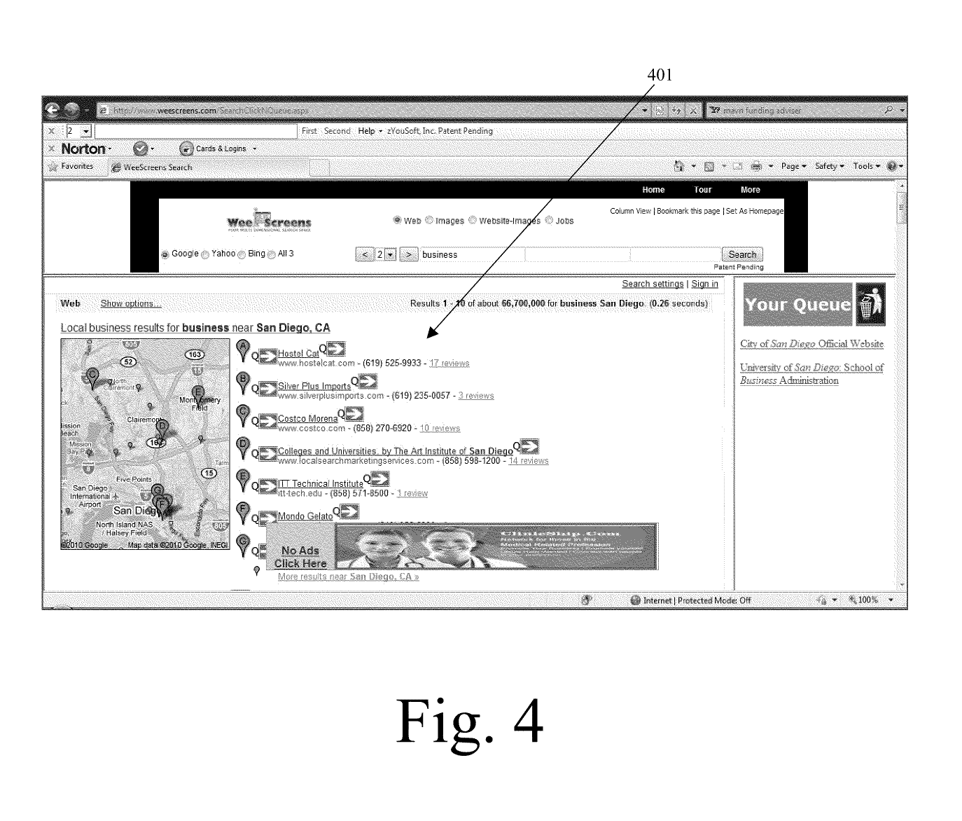

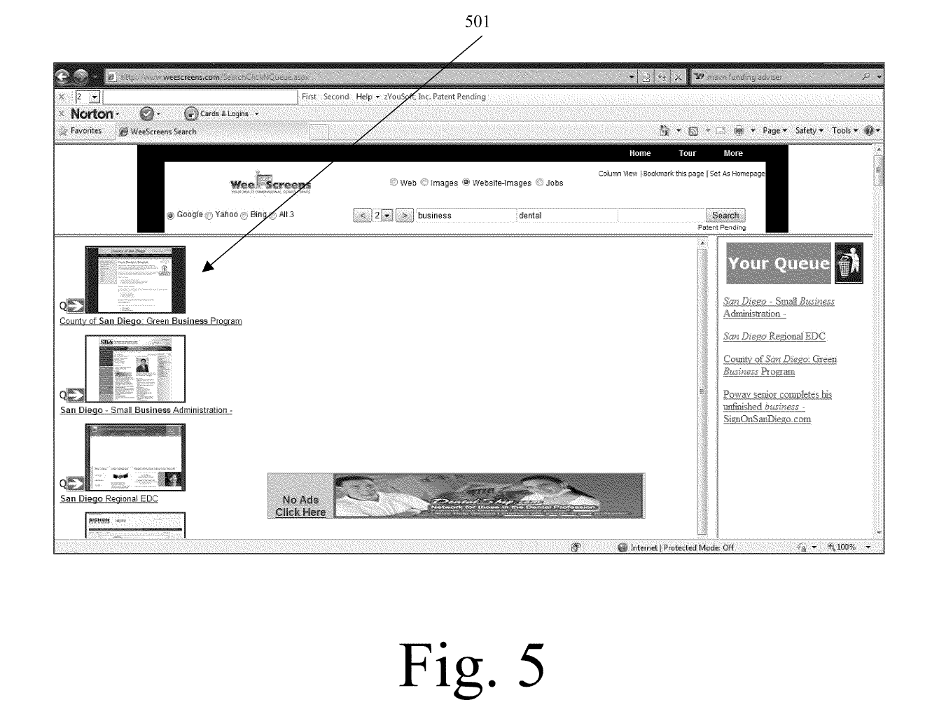

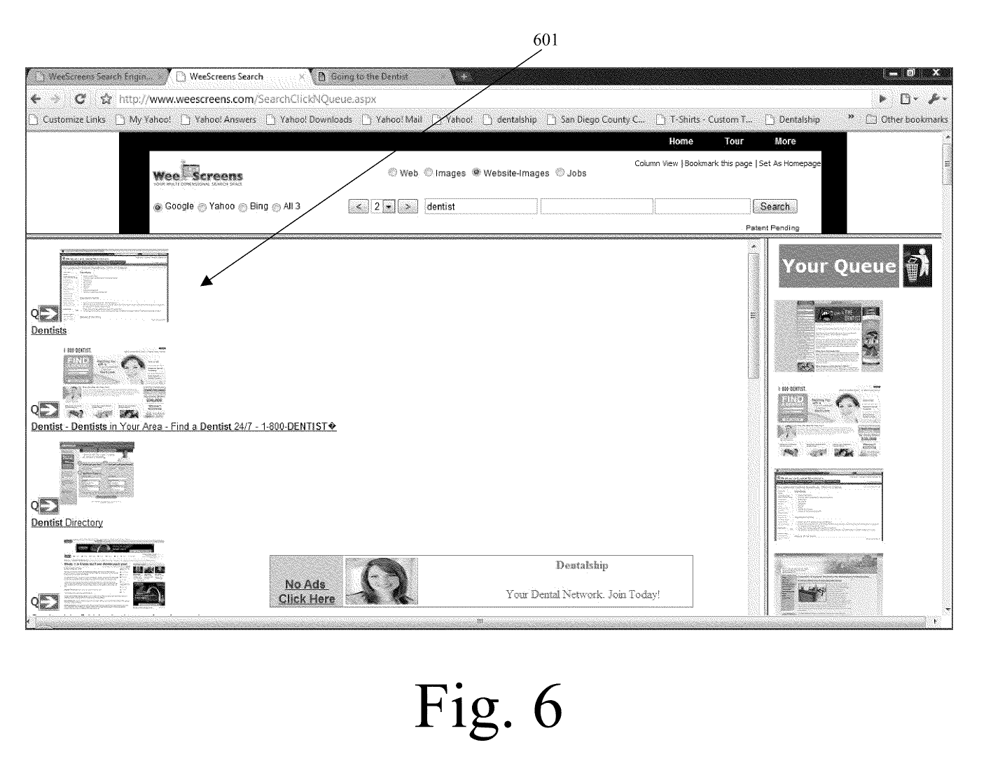

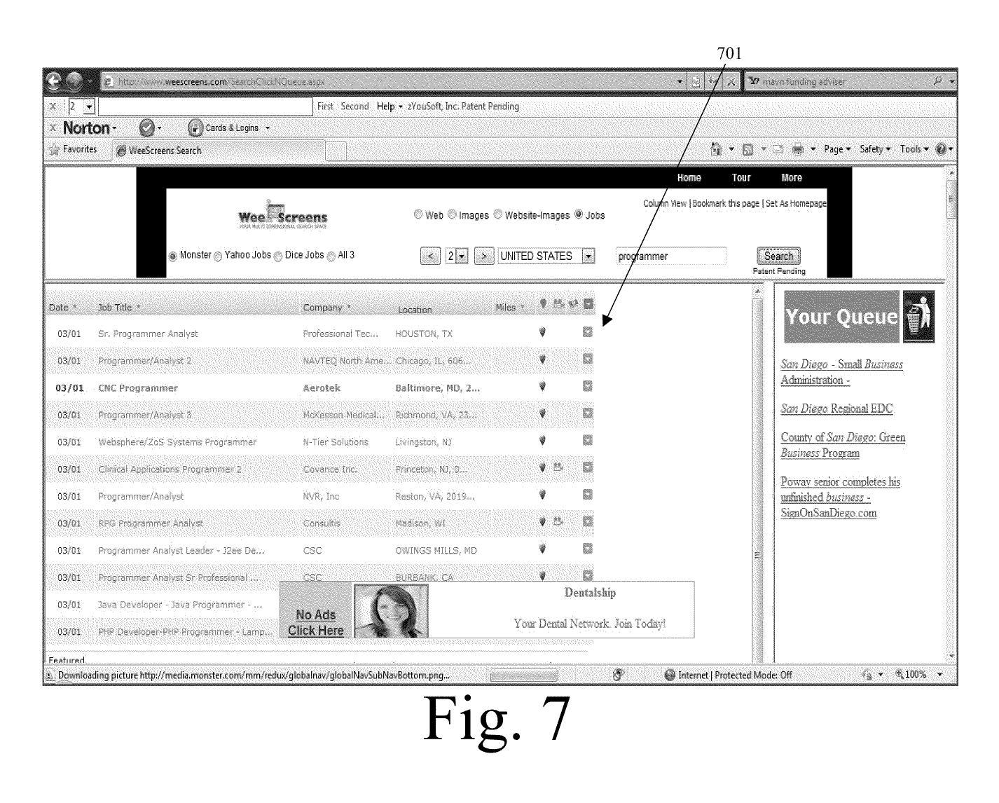

FIG. 2 illustrates a multi-frame configuration display for a simple search of one search engine 201 for one search term, that displays a plurality of search results 203 is the second frame 107. The present invention works the same as the column embodiment taught in the cited related patent application, except in this embodiment the pages are stacked on top of each other. The functionality requires a user to click on the arrow box 204 to queue a link 205 rather than search the result. Upon selection of the green arrow box 204 a copy of the link 206 will be placed in the users queue frame 108. Users can queue: web links 401 as shown in the web queue results in FIG. 4, Images 501 as show in FIG. 5, Website-Images 601 as shown in FIG. 6 and Jobs 701 as shown in FIG. 7 at the same time, or individually as illustrated in the screen shots shown in the Figures.

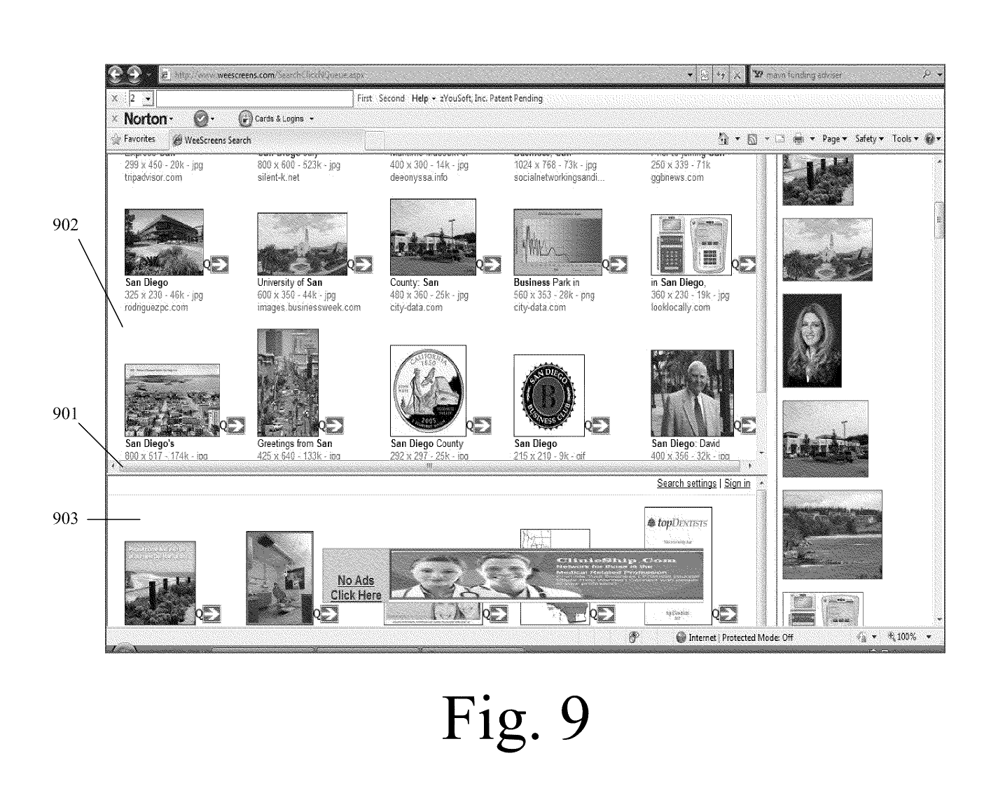

Now referring to FIG. 9, the present invention stacks the search pages instead of presenting them in column format as taught by the related patent applications from which this application is derived. In the present invention, the results of two or more search engines are stacked in the second frame 108 and divided by a scroll bar 901, which further defines the frame 108 into multiple sub-frames 902 and 903. The results of a first search engine are displayed in a first sub-frame 902 and the results of a second search engine are displayed in a second sub-frame 903 immediately below the first sub-frame 902 as the user scrolls down the second frame 108. This orientation essentially stacks the search results in the second frame 108.

By using a computer mouse a user can drag the edge of a frame 110 or 109 to left or right or top to bottom of the window screen to increase or decreases the width or height of the frames. The present invention displays multiple frames on one browser window 100.

The visual result of the present invention is the return of multiple frames in a single page providing a first frame section 102 for executing a search, a second frame section 107 for display of search results from one or more search engines using one or more sub-frames 902 and 903 to display the search results for each of the search engines, and a third frame 108 for display a user's custom created queue. Multiple websites are oriented side by side. This offers better visibility of websites in the frame with a smaller size.

The program module is an add-on to a browser; a User can select a plurality of frames to be displayed when searching websites. The website is downloaded from a server that is located or found on the Internet. The present invention enables users to view a plurality of search results from a plurality of search at the same time using one browser window 100.

The present invention teaches a frame configuration display to interact with different or similar Internet websites such as FACEBOOK.COM, GOOGLE.COM, YAHOO.COM or MSN.COM that interact with multi-framed pages on one Internet browser window screen to be viewed at the same time.

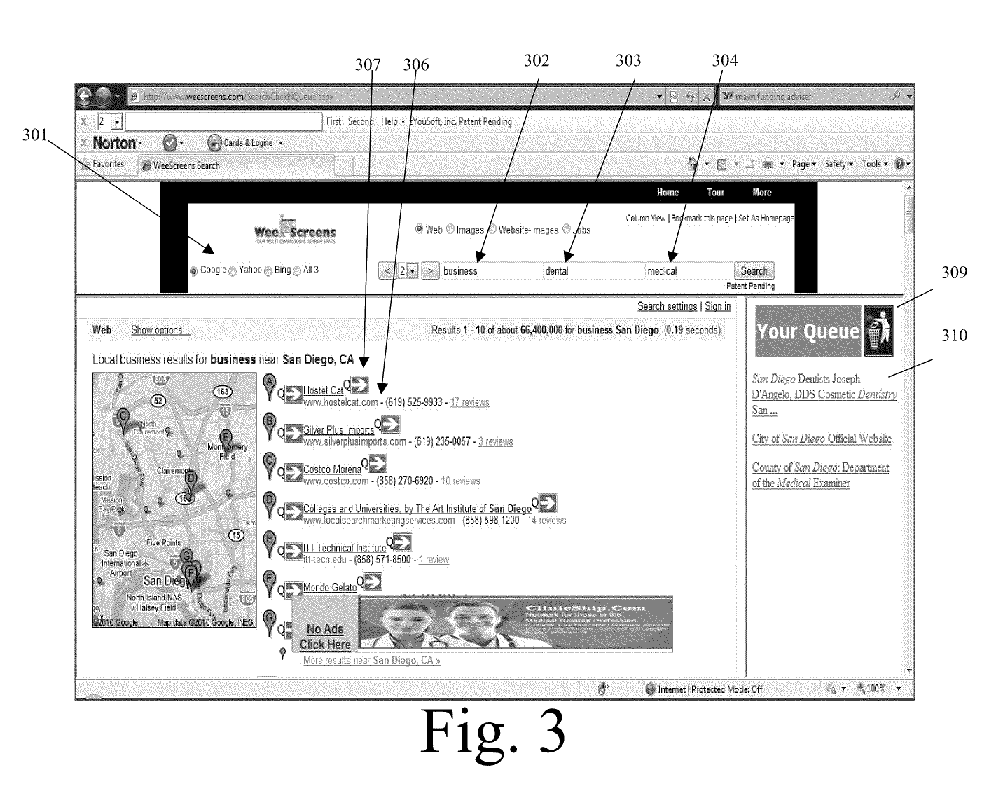

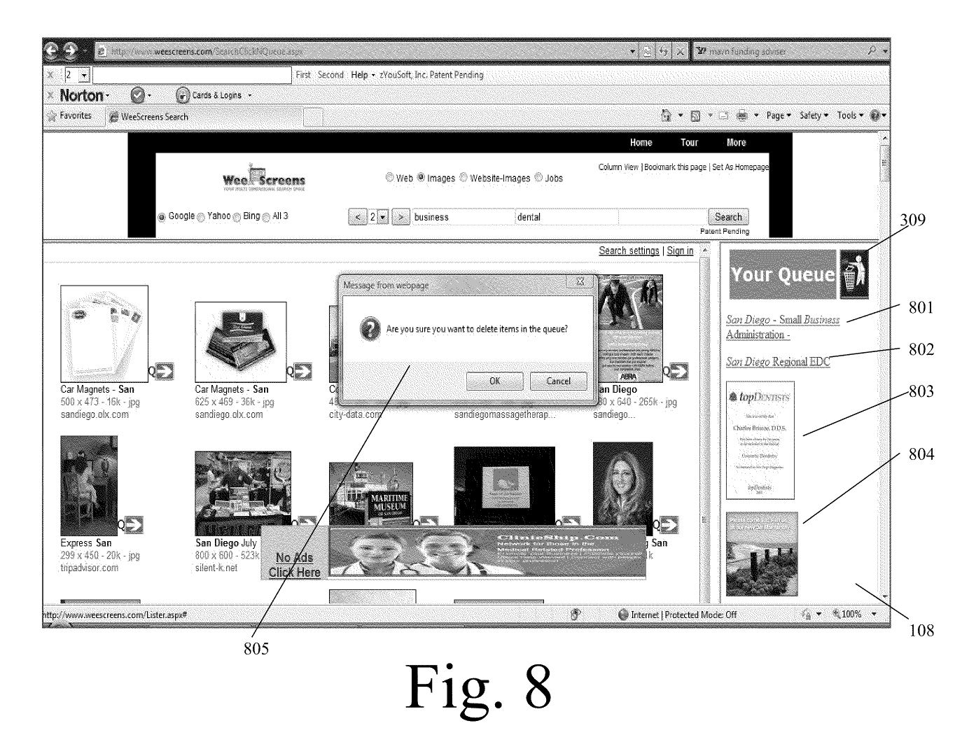

Referring to FIG. 3, the method for searching one or more search engines at the same time for one or more key words is shown. A user starts by opening the website which defaults to three frames 102, 107, 108. Next the user selects the search engines 301 they wish to be searched, enters the search terms 302, 303, and 304, and presses the “search” button 305. The results of the search are then returned in the second frame 107. The results can be displayed as standard links 306, images 501 as shown in FIG. 5, websites 601 as shown in FIG. 6, or jobs 701 as shown in FIG. 7. The functionality requires a user to click on the arrow box 307 associated with a link 306 to queue the link 306 rather than search the displayed search result. Upon selection of arrow box 307 associated with the link 306, a copy of the link 310 is placed in the users queue frame 108. This process can be repeated for any number of searches. The user can delete individual links 310 from their queue 108 are they can elect to delete all items 801, 802, 803, and 804 in their queue 108 by selecting the delete icon 309 as show in FIG. 8 and following the prompt 805.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A computer-implemented method of a single page, multi-frame display and interaction of multiple search engine results, the method comprising:
downloading a software module to a user's computer for execution,
running a browser on a user's computer;
opening a browser window;
running the software module as a web-based site;
selecting one or more search engines via a first frame in the browser;
entering one or more search terms via a first frame in the browser;
loading the contents of the search results from the search engines into a second frame in the browser;
creating a plurality of sub-frames frames in the second frame in the browser corresponding to the number of search engines selected;
creating boundaries dividing the sub-frames;
creating a third frame in the browser for storing user selected results in a queue;
creating boundaries dividing the frames;
displaying the search results as the original websites in each sub-frame of the second frame of the browser window corresponding to the search engine results received;
providing a selectable icon for each search engine result;
allowing selection of a search engine results by the icon;
transferring a copy of the search engine results to the third frame upon selection of the associated icon; and
creating a queue of selected search engine results in the third frame.

2. The method of claim 1 further comprising the step of:
orienting the first and third frames side by side in the browser.

3. The method of claim 1 further comprising the step of:
representing in each sub-frame of the second frame of the browser, one website page of data, and
downloading the website page of data from a server that is located or found on the Internet.

4. The method of claim 1 wherein the program module is an add-on to the browser.

5. The method of claim 1 wherein each sub-frame of the second frame represents one website search engine and one website search engine's page of data.

6. The method of claim 1 further comprising the step of:
downloading the software module from a server on the Internet.

7. The method of claim 1 wherein each frame is defined as having a top border, a bottom border, a left border, and a right border.

8. The method of claim 7 further comprising the step of:
using a computer mouse to drag the edge of each frame border to the left or right of the window screen to increase or decreases the width of the frame.

9. The method of claim 8 further comprising the step of:
condensing or expanding the frames by clicking and dragging on the side border, left or right, to read more of the text of a specific frame.

10. The method of claim 1 further comprising the step of:
enabling the viewing of a plurality of website search engine results at the same time using one browser from with multiple sub-frames equal to the number of search engines selected.

11. The method of claim 11 further comprising the step of:
searching a single page of a website search engine result from one website at the same time for a plurality of different websites.

12. The method of claim 1 further comprising the step of:
searching and viewing a plurality of website search engine results at the same time using only one browser window.

13. The method of claim 1 further comprising the step of:
returning search engine results as web links; and
queuing search engine results as web links upon selection of the associated icon in the third frame.

14. The method of claim 1 further comprising the step of:
returning search engine results as website images; and
queuing search engine results as website images upon selection of the associated icon in the third frame.

15. The method of claim 1 further comprising the step of:
returning search engine results as job listings; and
queuing search engine results as job listings upon selection of the associated icon in the third frame.
